(19) United States
(12) Patent Application Publication
(10) Pub. No.: US 2012/0067992 A1
(43) Pub. Date: Mar. 22, 2012

(54) Casting Post

(76) Inventor: Lester A. Brucker, Chokoloskee, FL (US)

(21) Appl. No.: 12/891,969

(22) Filed: Sep. 28, 2010

Related U.S. Application Data
(60) Provisional application No. 61/384,274, filed on Sep. 19, 2010.

(51) Int. Cl. A01K 89/01; A01K 91/02

(52) U.S. Cl. 242/230

(57) ABSTRACT

This invention provides a means to utilize the spring capability of the rod to launch a fishing lure. We provide an area on the bail of the reel, the Casting Post, to locate the lure on the closed bail when bending the rod into a position to launch the lure. The lure is launched by releasing the bail to the open position.

### FIELD OF THE INVENTION

The present invention relates to the addition of a Casting Post to the bail of a spinning type fishing reel.

### BACKGROUND OF THE INVENTION

There are some mechanisms in the prior art that utilize the kinetic energy of the fishing rod to cast a lure or projectile. These are presented in U.S. Pat. Nos. 4,656,773, 5,210,972, 5,695,139, and 6,612,064.

The type of fishing reel known as a ‘Spinning Reel’ is well known in the art. A typical spinning reel is shown in U.S. Pat. Nos. 5,118,048 and 7,222,809. A spinning reel typically comprises; a housing; an oscillating spool; a rotating handle extending from the housing; a rotor which rotates about the spool when the handle is turned; and a bail which is mounted on the rotor. When the bail is closed and rotates, line is wound onto the spool. When the bail is opened, line can be withdrawn from the spool. The bail is spring loaded so it is in either the open or the closed position.

Typically, in order to cast the line, a lure is attached to the end of the line, the bail is opened manually and the line is held by a finger until the rod is moved to the casting position. The finger is then released and the lure is thrown in the direction of the cast, spinning the line off of the spool.

Also, well known in the art is a trigger mechanism which allows the line to be held by the bail until the casting position has been reached. The bail is then opened by actuating the trigger, releasing the line, and the lure takes the line off of the spool. Typical trigger mechanisms are shown in U.S. Pat. Nos. 5,154,369 and 6,056,221.

The problem with both of these systems is that a great deal of practice is required to learn to release the line at exactly the right time. If released too soon, the lure flies into the air, and hits overhead objects, or does not go as far as it would if released at the right time. If released too late, the lure goes down into the water in front of the target area. It also takes a lot of practice to be able to cast the line in the exact direction that is desired.

Another problem is the difficulties that can happen in the backstroke of the cast. It is common to get caught on an object ,or a person, when the lure is behind you and out of sight

These problems are overcome by the use of this invention, the Casting Post. With the Casting Post, the lure is located on the Casting Post with the rod in a sprung condition, the rod is pointed in the direction that it is desired that the lure is to be cast. The bail is then opened and the lure is thrown in that direction. The distance thrown is determined by the amount of spring in the rod, which depends on how far the rod has been bent.

Another advantage is the ease of use of this invention. Many people, because of problems with age or health, can not cast a standard rod and reel assembly, but will be able to cast using an assembly with the Casting Post

### SUMMARY OF THE INVENTION

This invention provides a means to utilize the natural spring ability of the rod to launch the fishing lure in a controlled manner. It provides a rod and reel combination that allows anyone to cast accurately with a minimum of practice.

By making an area on the bail, the Casting Post, where the lure can be held when the rod has been sprung by pulling on the lure, the ability to launch the lure has been created. The release of the bail to the open position will then launch the lure in the direction that it is pointed. The distance that the lure will be cast is determined by the amount of spring that has been pulled into the rod.

The bail has a sprung open position and a sprung closed position. The Casting Post must be close enough to the pivot point of the bail that the spring holding the bail closed is not overcome by the tension of the rod

This invention works most readily with reels that have quick release mechanism for opening the bail of the reel, but can be used with a normal reel with some practice.

The Casting Post may be added to existing reels by drilling a hole in the proper place in the bail, and inserting the Casting Post. It could be pressed in, glued in, or screwed in, depending on the installers preference.

The Casting Post may be created on new reels by altering the bail to provide an area where the lure could be located on the body of the bail. It could be fabricated by locating a pin made of a different material into the bail when the bail was fabricated.

### BRIEF DESCRIPTION OF THE DRAWINGS

FIG. 1 is a perspective of the rod and reel assembly with a lure located on the Casting Post with the reel in the closed position.

FIG. 2 is a drawing of the Casting Post.

FIG. 3 is a perspective of the bail and the rotor to which it is attached. The bail is shown in the closed position

FIG. 4 is a perspective of the bail and the rotor to which it is attached. The bail is shown in the open position.

FIG. 5 is a Top Elevation of a typical bail

FIG. 6 is a Front Elevation of a typical bail

FIG. 7 is a Right Side Elevation of a typical bail

FIG. 8 is a Right Side Elevation of that bail showing how the casting Post could be made an integral part of the bail.

### DETAILED DESCRIPTION OF THE DRAWINGS

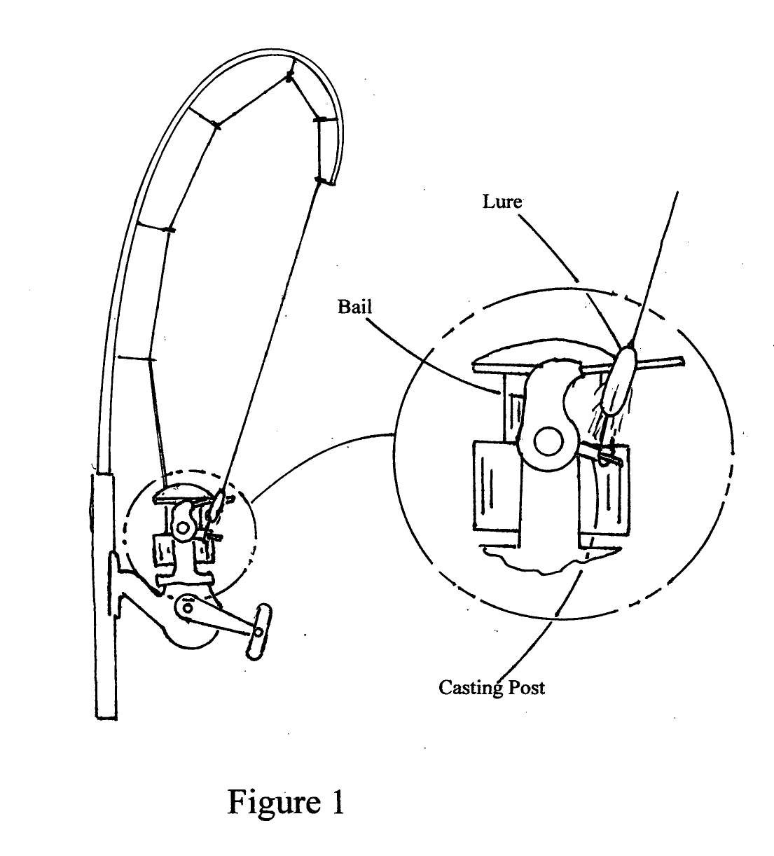

FIG. 1 shows the rod and reel assembly with a lure located on the Casting Post with the reel in the closed position. When the bail is opened, the lure will be released and will be cast using the energy stored in the bent rod.

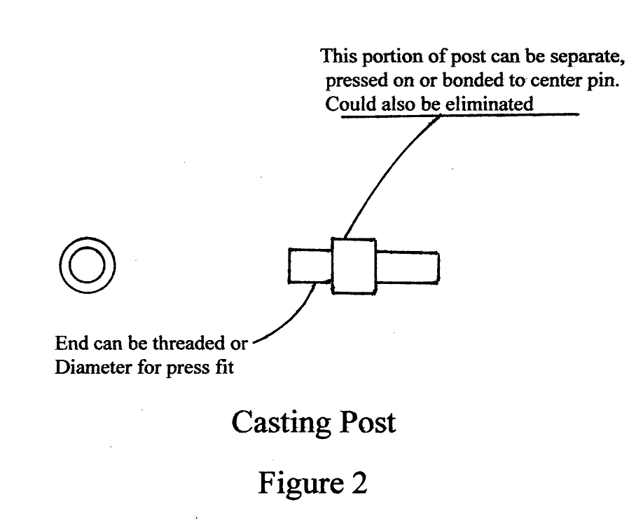

The Casting Post is shown in detail in FIG. 2. Note that the Casting Post might be pressed or glued into the bail, or it may be threaded and screwed in, depending on the choice of the fabricator. Likewise the Casting Post might be machined to the shape shown, or it could be made out of a pin with a sleeve pressed on or glued to it.

A spinning reel typically comprise; a housing; an oscillating spool; a rotating handle extending from the housing; a rotor which rotates about the spool when the handle is turned; and a bail which is mounted on the rotor. When the bail is closed and the rotor rotates, line is wound upon the spool. When the bail is opened, line can be withdrawn from the spool. The bail is spring loaded so it is either in the closed or the open position.

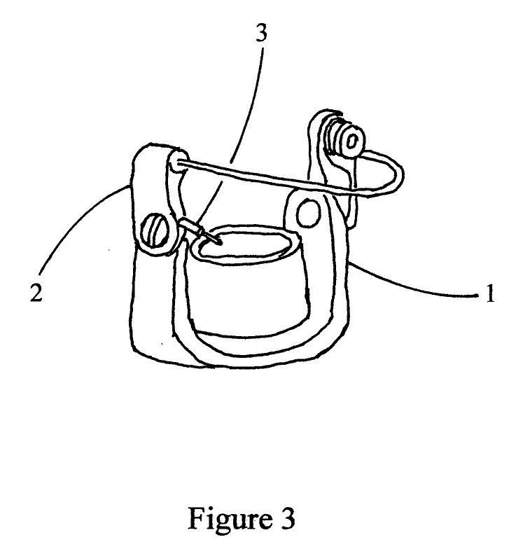

FIG. 3 Shows the rotor (1) the bail (2), and the Casting Post (3), with the bail in the closed position.

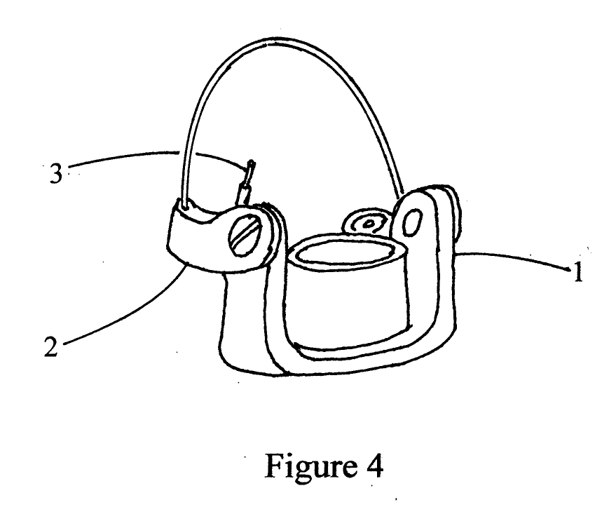

FIG. 4 Shows the rotor (1) the bail (2), and the Casting Post (3), with the bail in the open position.

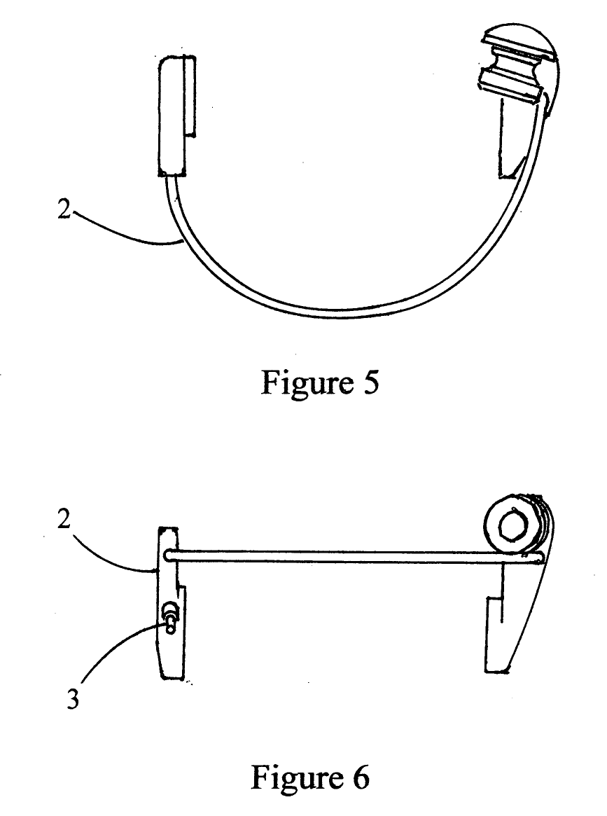

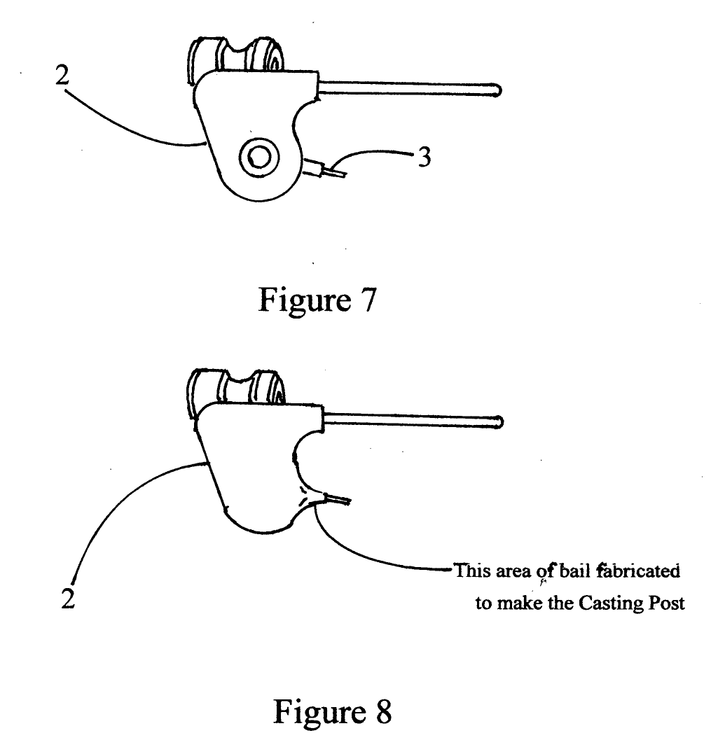

FIGS. 5, 6, and 7 show the Casting Post located on the bail.

FIG. 8 shows a configuration for manufacturing a bail with the Casting Post as an integral part of the bail. This area of the bail could be fabricated by inserting a pin made of a different material when the bail is fabricated.

I claim:

1-2. (canceled)

3. A Casting Post added to the bail of a spinning reel in a fishing system, including a flexible rod, having a position on one end to locate a reel, eyelets to control the location of a line throughout the length of the rod, including a tip eyelet, with a spinning reel attached to the rod, said spinning reel comprising; a housing; a rotating handle extending from said housing; a rotor which rotates about an oscillating spool when said handle is turned; said spool, having line spooled on it, said line then threaded thru said eyelets on said rod, and having a fishing lure attached to the end of said line; a bail which is mounted on said rotor; said bail, when closed and rotated, winds said line onto said spool; said bail, when opened allows said line to be freely released from said spool; said bail, when closed, having a mechanism allowing rotation in only one direction, acting as a brake, preventing said line from being drawn from said spool; said bail, being spring loaded to keep it in either the open or closed position when no tension is on said line; said bail, being constructed so that tension applied to said line causes said bail to be more tightly closed; said spool, having a separate, adjustable, braking system, which allows said line to be drawn from said spool, with said bail closed, at a controlled tension;
a) added to said bail, a pin, referred to as the Casting Post, inserted into it, upon which said lure can be located, flexing said rod, thus applying a force to said line, thus preparing said lure to be cast;
b) said Casting Post being positioned at an angle and in a location on said bail to contain said lure on said Casting Post when said bail is closed, releasing said lure when said bail is opened;
c) said Casting Post to be located close to center of said bail axis, said axis being the one around which said bail is opened and closed, so force from bending said rod does not open said bail, overcoming combined force of said bail spring keeping said bail closed and force that is a result of said line force holding said bail closed;
d) said force, being varied by changing the distance between said lure and the end of said rod, prior to locating said lure on said Casting Post;
e) allowing said lure to be cast by opening said bail, allowing said force to cast said lure, also allowing said line to be freely released from said spool.

4. A Casting Post, functioning as the Casting Post in claim 1, but formed or otherwise fabricated as an integral part of said bail.
